(19) United States
(12) Patent Application Publication
(10) Pub. No.: US 2007/0241073 A1
(43) Pub. Date: Oct. 18, 2007

(54) Organizer tray for use on lifting equipment

(76) Inventor: Andrew J. Wanda, Homer Glen, IL (US)

Correspondence Address: EDWARD D. GILHOOLY, 28 E. JACKSON BLVD., SUITE 423, CHICAGO, IL, 60604, US

(21) Appl. No.: 11/699,194

(22) Filed: Jan. 29, 2007

Related U.S. Application Data
(63) Continuation of application No. 10/856,522, filed on Jun. 1, 2004, now abandoned.

(51) Int. Cl. B25H 5/00

(52) U.S. Cl. 211/126.1

(57) ABSTRACT

An organizer tray for articles for use on an elevated platform of a lifting apparatus to provide access to a variety of items while work tasks are being performed by one or more individuals. The tray has four upright walls, a bottom wall and an open top to provide one or more compartment therein. A rear ledge and pair of side ledges support the tray on the rails of the platform of the lifting apparatus.

### BACKGROUND OF THE INVENTION

1. Field of the Invention

This invention relate in general to article receiving trays, and more particularly, to an organizer tray for receiving parts and other items for use by workmen on lifting equipment.

### SUMMARY OF THE PRIOR ART

Workmen, such as electricians, carpenters, refrigeration workers, and other tradesman, often perform installation and repair work within or on the exterior of buildings and the like while being elevated on lifting equipment. On common type of lifting equipment commonly in use is referred to as a scissors lift. A scissor lift is provided with an elevated platform from which a workman can perform his tasks. While elevated, the worker generally requires that a considerable amount of supplies to be available to him so that he can efficiently accomplish his work. For example, an electrician may require many items while performing electrical work, such as straps, fittings, connectors, couplings, and tools. Similarly, carpenters may need many types of nuts and bolts, nails and associated items.

In the past, the worker performing tasks on elevated equipment brings needed items in various containers and bags that often are positioned on the platform floor and do not provide convenient access and organization for optimum efficiency. Because of the lack of organization and convenient location of various items carried on the platform, maximum production of work and convenience to the individual is not attained by prior techniques. In addition, the presence of articles and containers on the platform of the lift leads to safety concerns, because of the potential of the workman tripping over the items or kicking the containers off the platform. For these reasons, it is advantageous in the industry to provide a more efficient and safe means of stowing work items and the like for use by workmen while elevated on a lift.

### SUMMARY OF INVENTION

It is therefore an objective of this invention to provide an organizer tray for use on the work platform of lifting equipment. The organizer tray herein disclosed is provided with a plurality of open compartments to receive articles needed for work tasks and arranged in an organized manner. The organizer tray herein is provided with ledges that project over portions of the rails conventionally present around the work platforms of lifting equipment, such as a scissors lift. The ledges effectively retain the organizer tray in a safe manner at a position elevated above the platform directly in front of the workmen. The positioning of the organizer tray allows the workman ready access to the items stored in the compartments with interfering with his work tasks. Each open compartment is to contain selected particular items of the type and in the arrangement which the worker prefers for his particular needs. Such items may be straps, fittings, couplings, connectors, and the like such as required by electricians. Carpenters may need other articles and tools that they can selectively store in a preferred arrangement in the compartments.

In its elevated position on the rails, the invention herein is highly convenient to the individual and provides greater efficiency and production, both beneficial to the employee and his employer. Because the organizer tray is elevated above the platform floor, greater occupational safety is present due to a reduction of the number of containers or other items needed on the platform of the lift. As another benefit, the organizer tray herein further prevents unintentional loss of working articles due to its efficient design while carrying the items on and off the platform and while being attached to the platform rail while elevated.

### BRIEF DESCRIPTION OF THE DRAWINGS

FIG. 1 is a side elevational view of the organizer tray of the invention;

FIG. 2 is an opposite side elevational view of the organizer tray of the invention;

FIG. 3 is a top plan view of the organizer tray of the invention;

FIG. 4 is a is a bottom plan view of the organizer tray of the invention;

FIG. 5 is an end elevational view of the organizer tray of the invention;

FIG. 6 is an opposite and elevational view of the organizer tray of the invention;

FIG. 7 is an end perspective view of the view of the organizer tray of the invention; and

FIG. 8 is an end perspective view of the view of the organizer tray of FIG. 7 mounted on the platform of lifting equipment.

### DESCRIPTION OF THE PREFERRED EMBODIMENT

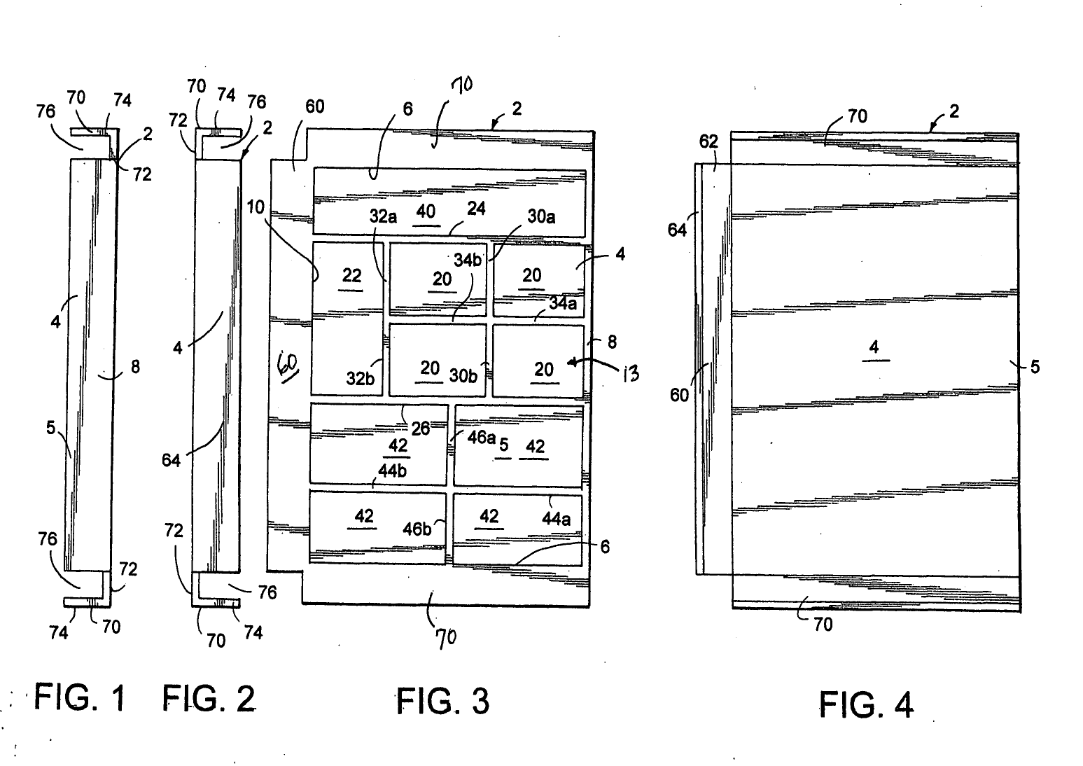

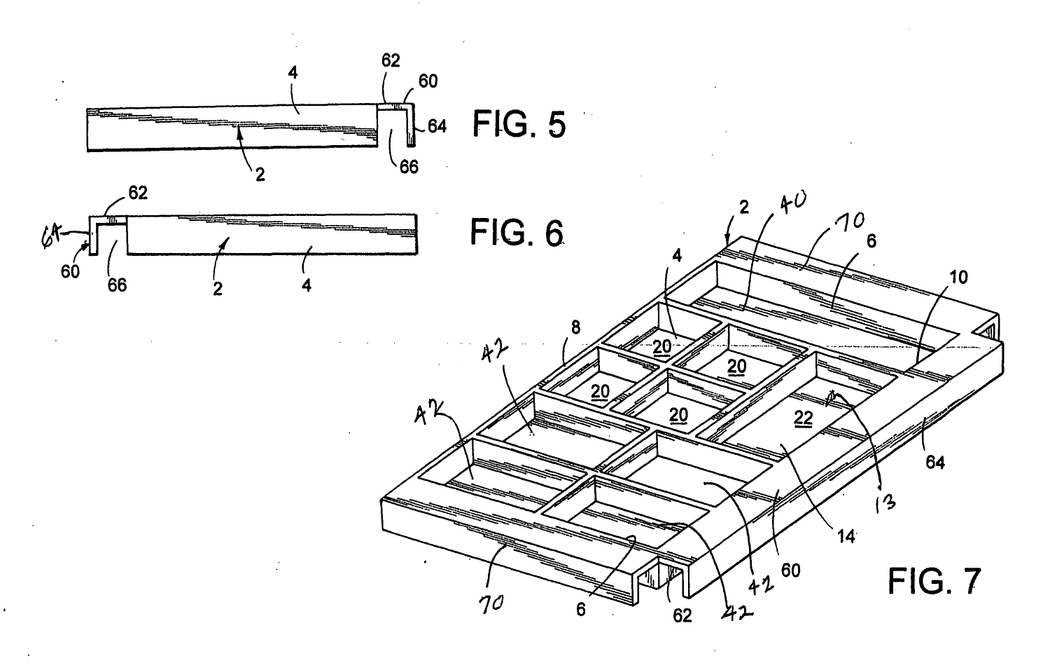

Referring now to FIGS. 1-8, there is illustrated the organizer tray of the invention, generally designated by reference numeral 2. Although the organizer tray 2 can be fabricated from metal and the like, it is herein described with the drawings from a plastic that is integrally molded or otherwise formed in one piece. The organizer tray 2 includes a central item receiving body 4 having upright bottom wall 5, a pair of opposed end walls 6, front wall 8 and rear wall 10 to form an open top 12 and providing a compartment section 13 for receiving articles as will be described.

With reference to FIGS. 3, 7, and 8, the central portion 14 of compartment section 13 is shown being provided with a plurality of separate article receiving compartments which are shown having various sizes and shapes for receiving a selected article or articles. As seen in FIGS. 3, 7, and 8, four generally square compartments 20 and a larger rear compartment 22 are formed in central portion 14 by dividing walls 24, 26, integrally interconnecting front wall 8 with rear wall 10. The four compartments 20 are respectively created by segments of dividing cross walls 30a, b, and 32a, 32b. Divider walls 34a and 34b respectively extend between front wall 8 and dividing cross walls 32a, b, and between divider walls 32a, 32b, and 34a, 34b in integral relationship. The rear compartment 22 is accordingly defined by a portion of rear wall 10, a portion of divider walls 24, 26 and wall 32a, b.

An elongated end compartment 40 is further provided at an end portion of compartment section 13 by a portion of front wall 8 and rear wall 10, one end wall 6, and divider wall 24. Four larger equal size rectangular compartments 42 are provided at the opposite end of body 4 and are disposed between one end wall 6, a portion of front wall 8 and rear wall 10. The compartments are divided by perpendicular wall segments 44a, 44b, and 46a, 46b. The top edge of the divider walls as previously described within body 4 extend generally to the height of front wall 8, rear wall 10, and end walls 6. It is within the scope of the invention to utilize other compartment sizes and configurations as desired than the compartments shown in FIGS. 3 and 7.

As seen in FIGS. 3, 4, 5, 6, and 7, an L-shaped ledge 60 is integrally formed on rear wall 10 and generally extends the width of body 4. The ledge 60 includes a top horizontal portion 62 integrally extending from an upper free end portion of rear wall 10. lip portion 64 lies in spaced parallel relationship to the end wall 10. A downwardly lip portion 64 provides a rail receiving open portion 66 as will be described. Further, as best seen in FIGS. 1, 2, 4, and 7 side L-shaped ledges 70 having horizontal portion 72 and downwardly extending lip portion 74 are integrally formed generally along the width of each of the end walls 6. The horizontal portion 62 extends from the upper edge portion of the end walls 6. The L-shaped side ledges 70 form an open rail receiving portion 76 as will be described. Although the rear ledge 60 and side ledges 70 are shown extending generally along the length of the rear wall 10 and end walls 6 respectively, it is within the scope of the invention that the rear ledge 60 and side ledges 70 extend along only a portion of or more than the length of the rear wall or end walls, if desirable.

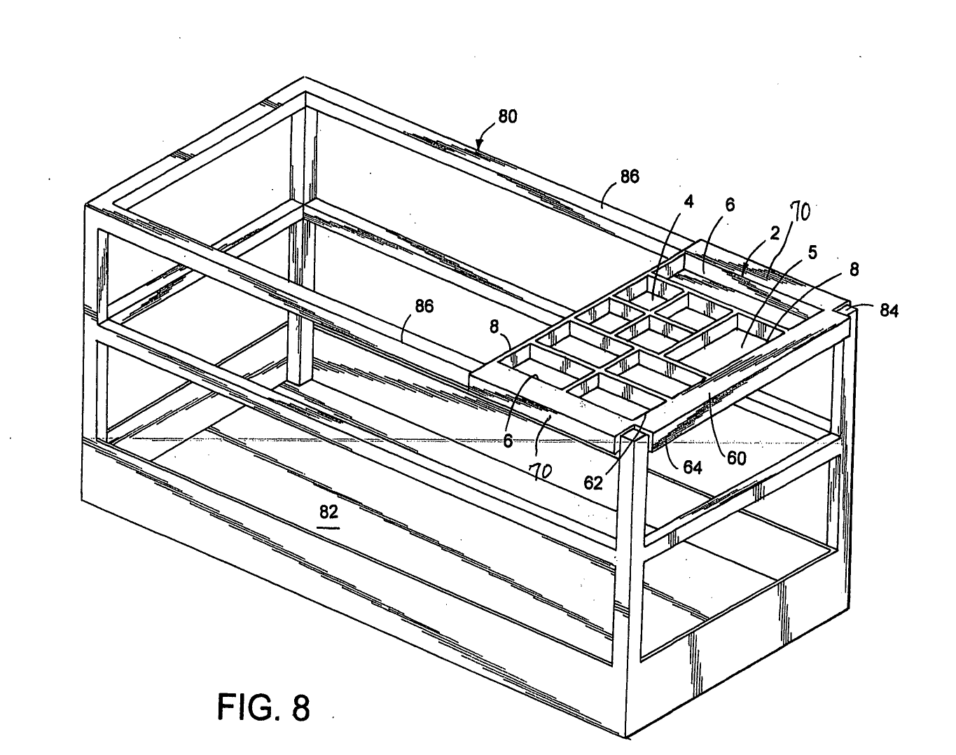

Referring to FIG. 8, there is shown organizer tray 2 mounted on the platform 80 of a conventional lift apparatus, such as, for example, a known so-called scissors lift. The platform 80 is raised and lowered by a workman, such as an electrician, carpenter, air conditioner personnel, and the like, to enable the individual or individuals to perform work tasks at elevated positions above a floor or ground adjacent building, building interior, equipment, and the like. The platform 80 may be raised or lowered by a lifting mechanism, such as one having a scissors design as previously described. The platform 80 has a floor 82 and an upper front rail 84 and a pair of side rails 86. A workman generally faces front rail 84 to perform tasks. As apparent from FIG. 8, the organizer tray 2 is immediately in front of the workman and provides access to the many work items in the compartments of tray 2 as he performs working tasks in an elevated position. The L-shaped rear ledge 60 of tray 2 is fit over the front rail 84 positioned within rail receiving portion 66, while the side L-shaped ledges 70 fit over side rails 86 position within rail receiving portion 76. Because two models of common lifts have side rails that vary in spacing by two to three inches, the overall width of side wall ledges 70 extend outward by an additional distance so that one size tray 2 can be positioned on either of the size variations of existing platforms. The width can be varied for universal use on both models by extending the width of horizontal portion 72 of the side L-shaped ledges by an appropriate distance.

1. An organizer tray for articles for support on the upper portion of the front rail and a pair of side rails being spaced by a predetermined distance in mounted relationship on a work platform of a lifting apparatus comprising,
a body defining at least one article receiving compartment,
said body having a front upright wall and a rear upright wall respectively intersecting with opposed end walls at respective lower ends, said front wall, said rear wall, and said end walls each having free upper edge portions defining an open top,
said body further having a bottom wall integrally connected to said lower edges of said front wall, said rear wall, and said opposed end walls,
a pair of spaced end ledges integrally connected to said opposed end walls and projecting therefrom for support of said body on an upper portion of the side rails,
a rear ledge integrally connected to said rear wall and projecting therefrom for support of said body on an upper portion of the front rail,
said pair of end ledges and said rear ledge each have a portion respectively extending perpendicular to said opposed end walls and said rear wall
said rear ledge includes a downwardly extending disposed lip lying in spaced relationship to said rear wall in integral relationship to said perpendicular portion for forming an open rear rail receiving compartment,
each of said pair of edge ledges includes a downwardly lip lying in spaced relationship to said opposed end walls in integral relationship to said perpendicular portion of said side ledge means for forming respective open end compartments for receiving the side rails, and each of said lips being spaced from said opposed end walls to form said compartments having opposed open ends for receiving the side rails within said compartments to safely support said body adjacent to the work platform.

2. (canceled)

3. The organizer tray according to claim 1 wherein said perpendicular portions of said rear ledge and said pair of end ledges respectively extend from said upper edge portion of said end walls and said upper edge portion of said rear wall.

4. (canceled)

5. (canceled)

6. The organizer tray according to claim 3 wherein each of said downwardly extending lips are spaced respectively from each other by a distance greater than the spaced predetermined distance of the side rails.

7. The organize tray according to claim 6 wherein said compartment includes a plurality of interconnected divider walls to form a plurality of compartments.
